(19) United States
(12) Patent Application Publication
(10) Pub. No.: US 2021/0154631 A1
(43) Pub. Date: May 27, 2021

(54) METHOD AND APPARATUS FOR MIXING MAGNETIC PARTICLES IN LIQUID MEDIUM

(71) Applicant: JBS Science Inc., Doylestown, PA (US)

(72) Inventors: Te-Yeu SU, Taoyuan (TW); Wei SONG, Doylestown, PA (US)

(21) Appl. No.: 17/105,957

(22) Filed: Nov. 27, 2020

Related U.S. Application Data
(60) Provisional application No. 62/941,700, filed on Nov. 27, 2019.

(51) Int. Cl. B01F 13/08

(52) U.S. Cl. CPC B01F 13/0809; B01F 2215/0034

(57) ABSTRACT

A method or mixing magnetic particles with a liquid medium in a reaction chamber is provided, comprising providing an external magnetic field to the reaction chamber causing the magnetic particles to move, such as swirl or oscillate, etc., substantially on a plane crossing the reaction chamber; and simultaneously controlling the magnetic particles to have a relative reciprocating movement at a non-zero angle to the plane. The magnetic field can be provided by rotating or reciprocating a magnet or electromagnet array around the reaction chamber, or by coordinately activating at least two electromagnets in an electromagnet array. The relative reciprocating movement of the magnetic particles can be realized by moving the reaction chamber or the magnet array, or by alternately activating another magnetic field provided by another electromagnet array. An apparatus applying the method is further provided. The technology can be applied widely and has the potential for realizing true automation.

### CROSS-REFERENCE TO RELATED APPLICATION

The present application claims the benefit of U.S. Provisional Application No. 62/941,700 filed on Nov. 27, 2019, the disclosure of which is hereby incorporated by reference in its entirety.

### FIELD OF THE INVENTION

The present disclosure relates generally to mixing technologies, specifically to mixing technologies using magnetic particles, and in more particular, to methods and apparatuses for mixing magnetic particles in a liquid medium by means of externally applied magnetic fields, which can achieve high efficiencies and have the potential for automation.

### BACKGROUND

Magnetic particles, or also known as magnetic beads, are a useful tool in the separation or isolation of target molecules from a liquid medium. Magnetic beads typically comprise a plurality of micro-sized and sphere-shaped ferromagnetic or paramagnetic particles that that are surface-functionalized, such as surface-coated with ligand molecules that can specifically recognize and stably bind with the target molecules. When an appropriate magnetic field is applied to the liquid medium containing a suspension of the magnetic particles, certain manipulation of the magnetic beads can be realized, such that a constant magnetic field can cause immobilization, while a magnetic field gradient can effect transport or rotation, of the magnetic beads in the liquid medium. Through these induced manipulations of the magnetic beads in the liquid medium, a variety of purported operations can be realized, such as mixing, and separation of the target molecules from the suspension, of the liquid medium.

Magnetic beads have been widely applied in the chemical, biological, and biomedical fields. For example, the mixing by vortex, rotation, and pipetting, the use of magnetic beads in biological processing and the use of magnetic field for the separation of magnetic beads from the reagents are commonplace in the fields of biology, biotechnology, and other bio-medical fields. Biological materials of interest, such as nucleic acid, proteins, glycans, or cells, etc., may be separated from a solution by the use of magnetic beads that are surface-functionalized with the ligands that can specifically bind to the target biological materials.

In existing magnetic beads manipulating technologies, vortex, rotation, and pipetting are the typical operations to the solution containing magnetic beads so as to keep the magnetic beads in suspension in, or to effectively capture or isolate the materials of interest from, the solution. However, there has not been a methodology that can manipulate homogenous or rigorous magnetic beads mixing by magnet(s). As such, the mixing of magnetic beads by means of magnet(s) has not yet seen applications in automation.

### SUMMARY

In a first aspect, a method for mixing magnetic particles with a liquid medium in a reaction chamber is provided. The method comprises: simultaneously

(1) providing a magnetic field to the reaction chamber, thereby causing the magnetic particles to move in the liquid medium substantially on a plane crossing the reaction chamber; and

(2) controlling such that the magnetic particles have a relative reciprocating movement with respect, and along a direction that has an angle, to the plane, wherein the angle is not zero.

Herein, according to some embodiments, the magnetic field is generated from a magnet array comprising at least one magnet, and each of the at least one magnet in the magnet array can optionally be a permanent magnet or an electromagnet.

There can be different embodiments for realizing the simultaneous step (1) of providing a magnetic field to the reaction chamber. In some embodiments of the method, the simultaneous step (1) can optionally comprise at least one of the following four manners:

rotating the magnet array around the reaction chamber;

spinning the reaction chamber;

driving the magnet array to reciprocatingly move; or

driving the reaction chamber to reciprocatingly move.

According to some embodiments, a number of the at least one magnet in the magnet array is one. Yet optionally, there can be more than one magnet in the magnet array.

According to some embodiments of the method, the simultaneous step (1) comprises:

providing an electromagnet array comprising at least two electromagnets in a proximity of the reaction chamber; and

coordinately providing electrical signals to the at least two electromagnets in the electromagnet array, thereby forming the magnetic field.

Herein optionally, the coordinately providing electrical signals comprises:

alternately providing electrical signals to the at least two electromagnets in the electromagnet array.

According to some embodiments, a number of the at least two electromagnets in the electromagnet array is three.

Further in the method disclosed herein, there can be different embodiments for realizing the simultaneous step (2) of controlling such that the magnetic particles have a relative reciprocating movement with respect, and along a direction that has an angle, to the plane.

In certain embodiments, the simultaneous step (2) comprises:

driving the reaction chamber to move reciprocatingly.

In certain other embodiments, the magnetic field is generated by a magnet array or an electromagnet array, and accordingly, the simultaneous step (2) comprises:

driving the magnet array or the electromagnet array to move reciprocatingly.

In a second aspect, the present disclosure further provides a method for mixing magnetic particles with a liquid medium in a reaction chamber. The method comprises:

(a) providing at least two magnetic fields to the reaction chamber, each capable of, upon activation, causing the magnetic particles to move in the liquid medium substantially on a plane crossing the reaction chamber corresponding thereto, wherein planes corresponding to the at least two magnetic fields on which the magnetic particles move are not on a same plane;

(b) controlling the at least two magnetic fields such that only one different magnetic field is alternately activated at a different timepoint.

Herein, each of the at least two magnetic fields can be generated by an electromagnet array, and as such, the step (a) of providing at least two magnetic fields to the reaction chamber comprises:

providing at least two electromagnet arrays in a proximity of the reaction chamber, wherein each of the at least two electromagnet arrays comprises at least two electromagnets.

Further in accordance, the step (b) of controlling the at least two magnetic fields comprises:

coordinately providing electrical signals to all electromagnets in the at least two electromagnet arrays.

According to some embodiments, the above step of coordinately providing electrical signals to all electromagnets in the at least two electromagnet arrays comprises:

alternately providing electrical signals to the at least two electromagnets of the each of the at least two electromagnet arrays.

According to some embodiments, a number of the at least two electromagnet arrays is two. Yet optionally, the number can be more than two.

Further according to some embodiments, a number of the at least two electromagnets in the each of at least two electromagnet arrays is three. Yet optionally, the number can be others (e.g. two, four, five, etc.).

In a third aspect, the present disclosure further provides an apparatus for mixing magnetic particles with a liquid medium in a reaction chamber, which substantially applies the method provided in the first aspect.

The apparatus comprises a magnetic field generating assembly and a reciprocation generating assembly. The magnetic field generating assembly is operably coupled with the reaction chamber, and is configured to generate a magnetic field to the reaction chamber so as to cause the magnetic particles to move in the liquid medium substantially on a plane crossing the reaction chamber. The reciprocation generating assembly is operably coupled with one or both of the reaction chamber and the magnetic field generating assembly, and is configured to cause the magnetic particles to have a relative reciprocating movement with respect, and along a direction that has a non-zero angle, to the plane.

Herein, the magnetic field generating assembly can comprise a magnetic array comprising at least one magnet, each in a proximity of the reaction chamber, and each of the at least one magnet can optionally be a permanent magnet or an electromagnet.

According to some embodiments of the apparatus, the magnetic field generating assembly further comprises a controller, which can comprise at least one of the following:

a first motor, which is operably connected with the magnet array, and is configured to drive the magnet array to rotate around the reaction chamber;

a second motor, which is operably connected with the reaction chamber, and is configured to drive the reaction chamber to spin;

a third motor, which is operably connected with the magnet array, and is configured to drive the magnet array to reciprocatingly move; or

a fourth motor, which is operably connected with the reaction chamber, and is configured to drive the reaction chamber to reciprocatingly move.

According to some embodiments, a number of the at least one magnet in the magnet array is one. Yet the number can optionally be more than one.

According to some embodiments of the apparatus, the magnetic field generating assembly comprises an electromagnet array and a first controller. The electromagnet array comprises at least two electromagnets, each in a proximity of the reaction chamber. The first controller is communicatively coupled to each of the at least two electromagnets, and is configured to coordinately provide electrical signals to the at least two electromagnets in the electromagnet array so as to compositely form the magnetic field.

Herein optionally, the first controller is configured to alternately provide electrical signals to the at least two electromagnets in the electromagnet array.

According to some embodiments, a number of the at least two electromagnets in the electromagnet array is three. Yet the number can optionally be others.

In any embodiments of the apparatus described above, the reciprocation generating assembly can be realized in different manners.

Optionally, the reciprocation generating assembly can comprise a fifth motor, which is operably connected with the reaction chamber, and is configured to drive the reaction chamber to move reciprocatingly.

In embodiments where the magnetic field is generated by a magnet array or an electromagnet array, the reciprocation generating assembly can optionally comprise a sixth motor, which is operably connected with the magnet array, and is configured to drive the magnet array or the electromagnet array to move reciprocatingly.

In a fourth aspect, the present disclosure further provides an apparatus for mixing magnetic particles with a liquid medium in a reaction chamber, which substantially applies the method provided in the second aspect.

The apparatus comprises a magnetic particle manipulating assembly, which is operably coupled with, and configured to provide at least two magnetic fields to, the reaction chamber. Each of the at least two magnetic fields is capable of, upon activation, causing the magnetic particles to move in the liquid medium substantially on a plane crossing the reaction chamber corresponding thereto, and planes corresponding to the at least two magnetic fields on which the magnetic particles move are not on a same plane. The at least two magnetic fields are configured such that only one different magnetic field is alternately activated at a different timepoint.

Herein, the magnetic particle manipulating assembly can comprise at least two electromagnet arrays and a second controller. Each of the at least two electromagnet arrays comprises at least two electromagnets, and each of the at least two electromagnets in the each of the at least two electromagnet arrays is in a proximity of the reaction chamber. The second controller is communicatively coupled to, and is configured to coordinately providing electrical signals to, all electromagnets in the at least two electromagnet arrays, so as to form the at least two magnetic fields.

According to some embodiments of the apparatus provided herein, the second controller is configured to alternately provide electrical signals to the at least two electromagnets of the each of the at least two electromagnet arrays.

According to some embodiments, a number of the at least two electromagnet arrays is two. Yet the number can be more than two.

According to some embodiments, a number of the at least two electromagnets in the each of the at least two electromagnet arrays is three. Yet the number can be others.

### BRIEF DESCRIPTION OF THE DRAWINGS

FIG. 1 shows a schematic diagram of the working mechanism of a magnetic particles mixing method according to some embodiments of the disclosure;

FIG. 2 illustrates the working mechanism of certain embodiments of the magnetic particles mixing method whereby the magnetic particles swirl in the liquid medium in the reaction chamber;

FIG. 3A illustrates the mixing of the magnetic particles with the liquid medium utilizing a rotating magnet array according to some embodiments of the mixing method;

FIG. 3B illustrates the immobilization of the magnetic particles utilizing the rotating magnet array as shown in FIG. 3A;

FIG. 4A illustrates the mixing of the magnetic particles with the liquid medium utilizing a stationary electromagnet array according to some other embodiments of the mixing method;

FIG. 4B illustrates the immobilization of the magnetic particles utilizing a stationary electromagnet array as shown in FIG. 4A;

FIGS. 5A and 5B respectively illustrate two different embodiments of the mixing method where the magnetic field generated can cause the magnetic particles to oscillate in the reaction chamber;

FIG. 6 shows a schematic diagram of the working mechanism of a magnetic particles mixing method according to some other embodiments of the disclosure;

FIGS. 7A and 7B respectively illustrate the working of the embodiments of the magnetic particles mixing method shown in FIG. 6 at two different timepoints;

FIG. 8A illustrates the mixing of the magnetic particles with the liquid medium utilizing two stationary electromagnet arrays according to some embodiments of the mixing method;

FIG. 8B illustrates the immobilization of the magnetic particles utilizing the two stationary electromagnet arrays as shown in FIG. 8A;

FIGS. 9A and 9B respectively illustrate the two working modes of one specific embodiment (i.e. Example 1) of the magnetic particles mixing apparatus that realize two different manipulations of the magnetic particles;

FIG. 9C illustrates a top sectional view of the apparatus shown in FIGS. 9A-9B;

FIGS. 10A and 10B respectively illustrate the two working modes of one specific embodiment (i.e. Example 2) of the magnetic particles manipulating apparatus that realize two different manipulations of the magnetic particles;

FIG. 10C illustrates a top sectional view of the apparatus shown in FIGS. 10A-10B;

FIGS. 11A-11F are representations of various stages during beads mixing and separation driven by magnet in a prototype device, with FIG. 11A showing a prototype device, FIGS. 11B-11F respectively showing the formation of a swirling beads cloud at the bottom of the tube (FIG. 11B), the center of the tube (FIG. 11C), or toward the top of the tube (FIG. 11D), and as a homogenously stirring in the entire tube (FIG. 11E), and FIG. 11F showing the immobilization of the magnetic particles by fixing a magnet at a desired position; and

FIGS. 12A and 12B respectively show a DNA recovery comparison between vortexing and magnet mixing, where DNA was added into the DNA binding solution with 1 m-diameter ProMag silica beads (FIG. 12A) or 0.1 m-diameter MagBio carboxylated beads (FIG. 12B) and mixed by either a vortex or magnet setting in the prototype, as shown in FIG. 11A for 10 and 20 min. At the end of mixing, beads separation was performed and DNA was recovered from elution of DNA from the beads. The eluted DNA was quantitated by the Qubit fluorometric DNA quantification (ThermoFisher Scientific) and percent of the recovery from the input amount of DNA by vortex mixing (dashed line) or by magnetic field mixing (solid line) were calculated and plotted as to the time of the mixing.

### DETAILED DESCRIPTION

In a first aspect, the present disclosure provides a method for mixing magnetic particles with a liquid medium in a reaction chamber, which can be referred to as “magnetic particles mixing method”, “mixing method”, or “method” hereinafter.

According to some embodiments, the magnetic particles mixing method comprises simultaneously:

S100: providing a magnetic field to the reaction chamber, thereby causing the magnetic particles to move in the liquid medium substantially on a plane crossing the reaction chamber; and

S200: controlling such that the magnetic particles have a relative reciprocating movement with respect, and along a direction that has a non-zero angle, to the plane.

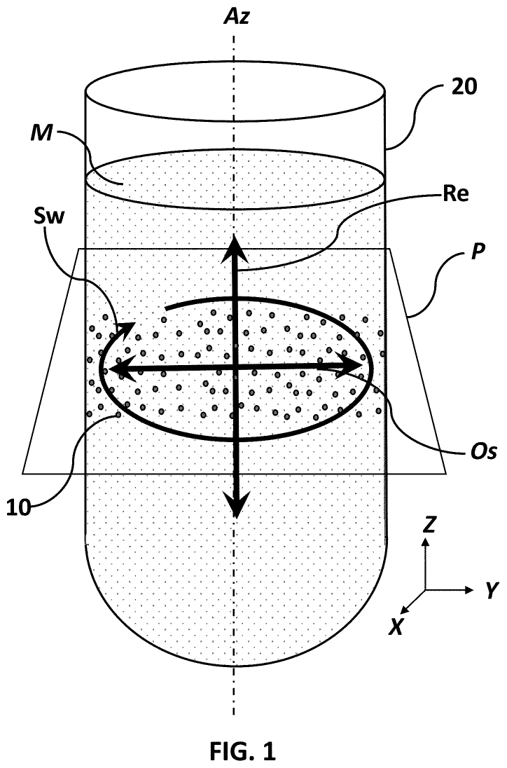

FIG. 1 shows a schematic diagram illustrating the working mechanism of the embodiments of the magnetic particles mixing method as described above. As shown in the figure, a plurality of magnetic particles 10 are suspended in the liquid medium Min the reaction chamber 20.

An external magnetic field (not shown in this figure) is externally provided to the magnetic particles 10, under which the magnetic particles 10 can move in the liquid medium M substantially on a plane P that crosses the reaction chamber 20 (i.e. “movement plane”, which is substantially parallel to a plane formed by the X-axis and the Y-axis in the XYZ coordinate system shown in the figure). Herein, the movement plane P is determined by the external magnetic field. As used herein, the term “move”, “moving”, “movement” or alike, is interpreted to include any motion of the magnetic particles inducible by an externally applied magnetic field that involves a physical displacement of the magnetic particles with reference to the reaction chamber 20, which can include swirl/swirling, oscillate/oscillating, or any other types of movement.

In the embodiments provided herein, under the external magnetic field, the magnetic particles 10 can optionally form a swirling magnetic particles cloud with a swirling direction Sw (as illustrated by the clockwise arrow in FIG. 1, yet can also be counterclockwise as well, depending on the rotating direction of the magnetic field) substantially on the plane P within the reaction chamber 20, yet can optionally form an oscillating magnetic particles cloud with an oscillating direction Os (as illustrated by horizontal double-headed arrow in FIG. 1, yet can also be other directions as well, depending on the oscillating direction of the magnetic field). Further optionally, under the external magnetic field, the magnetic particles 10 can have both the swirling movement and the oscillating movement, or other types of external magnetic field-inducible movement as well. There are no limitations herein. Further optionally and preferably, the swirling and/or oscillating magnetic particles cloud thus induced by the external magnetic field is/or homogenous, which can result in an optimal mixing efficiency for the method.

In the embodiments of the method provided herein, the magnetic particles 20 are further controlled to have a simultaneous relative reciprocating movement with respect to the plane P (the direction of such reciprocating movement is indicated by the thick vertical double-headed arrow Re) along a direction Az that is substantially perpendicular to the plane P (i.e. substantially parallel to the Z-axis in the XYZ coordinate system shown in the figure).

In other words, the embodiments of the magnetic particles mixing method as set forth above and illustrated herein substantially control the magnetic particles contained in the liquid medium in the reaction chamber simultaneously to:

(a) move (e.g. swirl, oscillate, etc.) on a plane within the reaction chamber in an external magnetic field inducible manner; and

(b) have a relative reciprocating movement with respect to the plane.

It is to be noted that the method shown in FIG. 1 serves only illustrating purposes only, and there is no limitation to the reaction chamber, to the movement plane P for the magnetic particles, or to the simultaneous relative reciprocating movement of the magnetic particles. The reaction chamber can have a spatial configuration other than the upright configuration as shown in FIG. 1, which can be, for example, horizontally arranged, or have any other angles to the horizontal plane. Similarly, the movement plane P can have a spatial configuration other than having a right angle to the center axis of the reaction chamber as shown in FIG. 1, which can be any other angle. The relative reciprocating movement of the magnetic particles 20 along the direction Az as illustrated in FIG. 1 is also not required. The disclosure intends to cover any direction of the relative reciprocating movement of the magnetic particles 20, as long as the direction is not on the same plane as the movement plane P (i.e. the direction has a non-zero angle with the movement plane P).

The move plane P can have a certain degree with the horizontal plane, such as 10

Depending on different embodiments, there can be different ways for generating the external magnetic field to realize the above movement (a), and/or for realizing the above movement (b), of the magnetic particles.

With regard to the movement (a), depending on different configurations, the magnetic field may be configured to cause the magnetic particles to move in different manners.

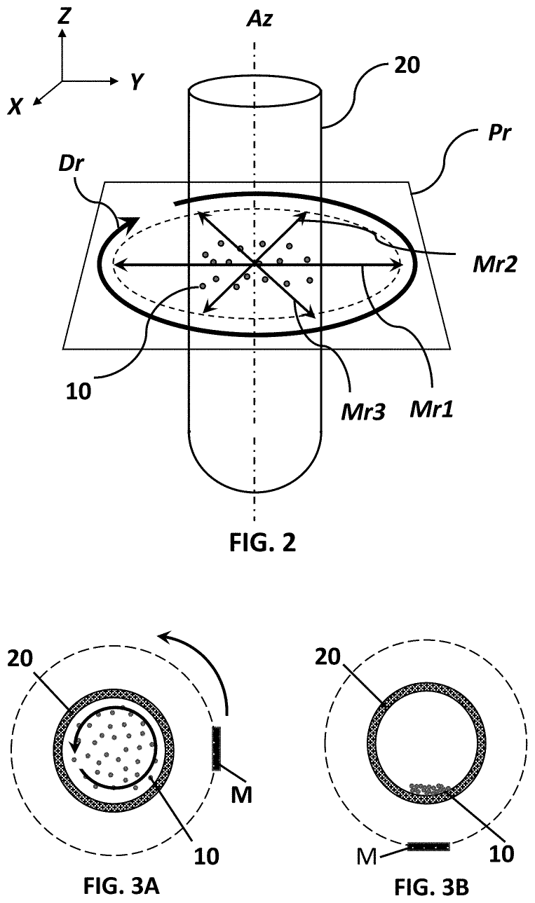

FIG. 2 illustrates the working mechanism of certain embodiments of the magnetic particles mixing method whereby the magnetic particles swirl in the liquid medium in the reaction chamber. As shown in the figure, a rotating magnetic field is provided to the magnetic particles 10, which has a plane of rotation Pr (i.e. “rotation plane”, which is substantially the movement plane P shown in FIG. 1) and a direction of rotation Dr (i.e. “rotation direction”, as shown by the clockwise arrow in the figure, which can also be counterclockwise direction, and the three double-headed arrows Mr1, Mr2, and Mr3 within the circle formed by the counterclockwise arrow Dr indicate directions of the magnetic field at three different time points). Under the effect of the rotating magnetic field, the magnetic particles 20 can swirl within the reaction chamber 20 on substantially the rotation plane Pr, and can preferably form a homogenous swirling magnetic particles cloud (not shown in the figure) at appropriate conditions.

Herein, the rotating magnetic field can, according to some embodiments, be generated by rotating a magnet array comprising one or more permanent magnets or electromagnets around the reaction chamber.

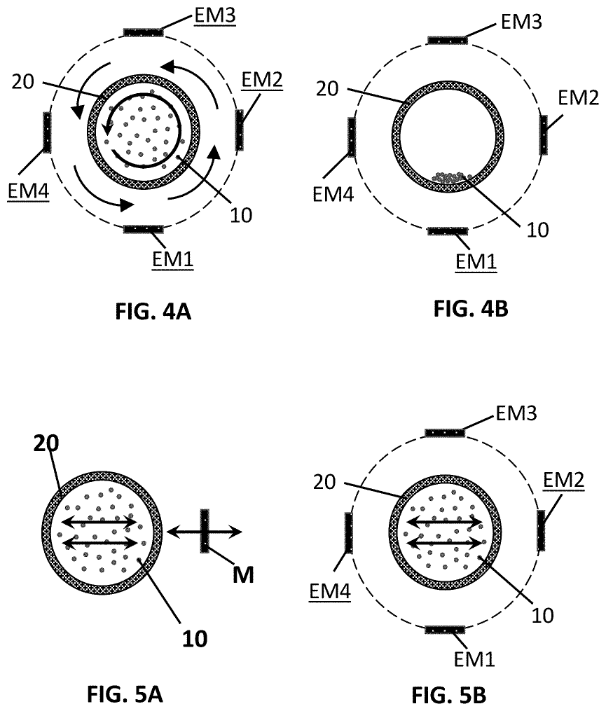

FIG. 3A illustrates one such specific embodiment, where the magnet array comprises only one magnet, which can optionally be a permanent magnet or an electromagnet. As shown in the figure, the one single magnet M is rotating on a ring (as illustrated by the circle with dotted line) around the reaction chamber 20 at one direction (e.g., the counterclockwise direction, as indicated by the arrow, but can alternatively be a clockwise direction), thereby causing the generation of a rotating magnetic field as illustrated in FIG. 2. Under the rotating magnetic field, the magnetic particles 10 can thus form a swirling magnetic particle cloud (as indicated by the circular arrow within the reaction chamber 20) which, if combined with a simultaneous relative reciprocating movement of the magnetic particles 10 in a direction that has a non-zero angle the rotation plane (especially in a direction that is perpendicular to the rotation plane), can allow for an efficient mixing for the magnetic particles 10 with the liquid medium.

It is further noted that when the single magnet M stops rotating, as illustrated in FIG. 3B, a stationary magnetic field can thereby be formed, which allows the magnetic particles 10 to immobilize on a portion of an inner wall of the reaction chamber 20 that immediately faces the magnet M (i.e. formation of a pellet). As such, the magnetic particles can be separated from the liquid medium, which further allows for other subsequent manipulations of the magnetic particles. For example, by means of magnetic particles that are functionalized with ligand molecules that specifically bind to the target molecules, the target molecules in a solution can be recapitulated from the immobilized magnetic particles.

According to some other embodiments, a magnet array comprising one or more permanent magnets or electromagnets can be stationarily arranged in a proximity of a spinnable reaction chamber. The reaction chamber is controlled to spin, thereby allowing the magnetic field produced by the magnet array to relatively rotate with regard to the magnetic particles contained in the liquid medium in the reaction chamber. The working mechanism is similar to the embodiments as described above and illustrated in FIGS. 3A and 3B, and will be skipped herein.

According to some other embodiments, the rotating magnetic field described above and illustrated in FIG. 2 can be generated by means of an electromagnet array comprising N electromagnets (N>1) that are each stationarily arranged in a proximity of the reaction chamber. Herein, the number N of the electromagnets in the electromagnet array can vary, depending on practical needs, and can be 2, 3, 4, . . . . It can be further configured such that the N electromagnets are substantially the same, and are arranged in cyclic symmetry, but it is only optional. In these embodiments of the mixing method, it can be further configured such that electrical signals are provided to these N electromagnets in the electromagnet array in a certain specific manner, e.g. the electrical signals are sequentially and alternately provided to the N electromagnets so as to sequentially and alternately activate these N electromagnets), thereby generating the rotating magnetic field.

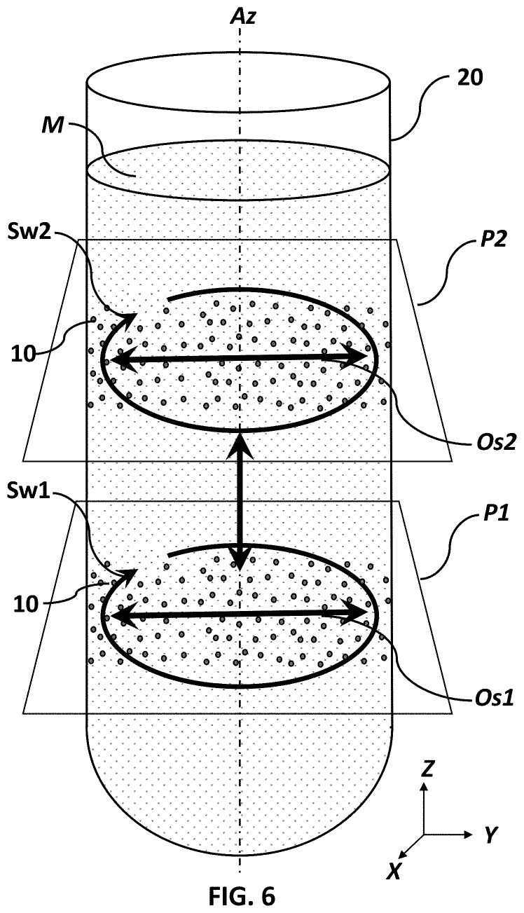

FIG. 4A illustrates one such specific embodiment as described above, where the electromagnet array comprises a total of four electromagnets (i.e., EM1, EM2, EM3 and EM4). As shown in the figure, the four electromagnets are arranged at a spatially equal distance on a ring that has a substantially same center as the reaction chamber 20, and are configured to individually receive electrical signals (such as current signals) from a controller to thereby be activated to generate a corresponding magnetic field. When these four electromagnets are activated in certain well-coordinated manner, a composite rotating magnetic field can be generated, which may cause the magnetic particles 10 to swirl in the liquid medium in the reaction chamber 20.

For example, when electrical signals are sequentially and alternately provided to the four electromagnets (i.e. in an alternate sequence of EM1, EM2, EM3, EM4, EM1, . . . ) in the electromagnet array, a rotating magnetic field can be generated. Under the rotating magnetic field, the magnetic particles 10 can thus form a swirling magnetic particle cloud within the reaction chamber 20. However, it is noted that other manners to coordinate the working of these four electromagnets so as to induce the magnetic particles to swirl in the liquid medium in the reaction chamber 20 are also possible.

It is further noted that when an electrical signal is provided to only one of the four electromagnets (i.e. EM1) in the electromagnet array for activation whereas no electrical signal is provided to other electromagnets (i.e. EM2, EM3 and EM4), a stationary magnetic field can be generated by the electromagnet EM1 to thereby realize the immobilization (i.e. formation of a pellet) of the magnetic particles 10 from the liquid medium in the reaction chamber 20, as illustrated in FIG. 4B, which in turn may facilitate the subsequent capture or other manipulations of the magnetic particles.

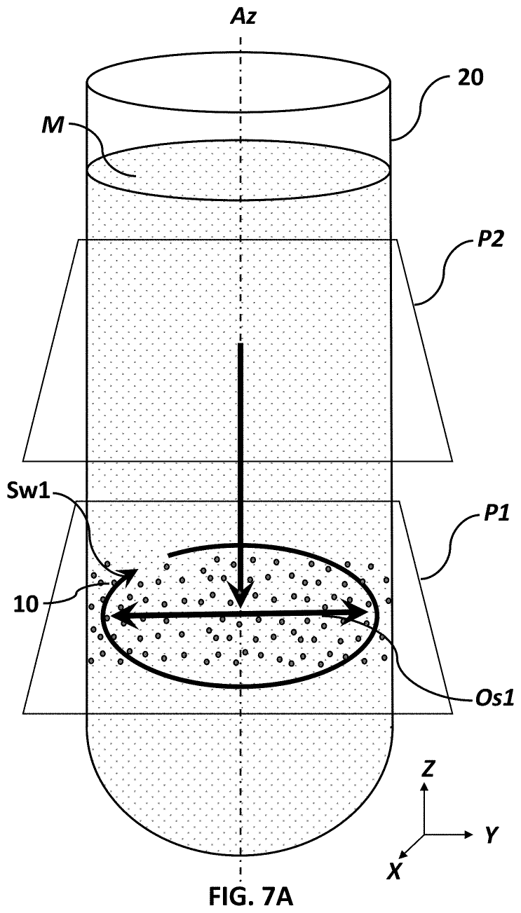

In addition to the embodiments illustrated to FIGS. 3A and 4A where the magnetic field generated by the magnet/electromagnet array can cause the magnetic particles to swirl in the liquid medium in the reaction chamber, according to some other embodiments, the magnet/electromagnet array-generated magnetic field can cause the magnetic particles to oscillate in the liquid medium in the reaction chamber, as illustrated in FIGS. 5A and 5B.

In one specific embodiment as illustrated in FIG. 5A, a magnet array comprising only one single magnet M is arranged in the proximity of the reaction chamber 20, and is configured to be movable reciprocatingly relative to the reaction chamber (e.g. to and from the reaction chamber 20, as indicated by the double headed arrow). When the magnet Mis moving reciprocatingly, the magnetic field produced from the magnet M thus becomes an oscillating magnetic field, which can cause the magnetic particles 10 to oscillatingly move (as indicated by the two double-headed arrows drawn in the reaction chamber 20) in the liquid medium in the reaction chamber 20. When the magnet M stops moving, a stationary magnetic field can cause the magnetic particles to immobilize (not shown). It is noted that in the embodiments illustrated in FIG. 5A, although the magnet M has a reciprocating movement to and from the reaction chamber 20, it is only optional, and it is possible that the magnet M performs such reciprocating movement along other directions, such as a sideway movement (i.e. the direction of movement is not pointing to the reaction chamber 20, not shown), which can also cause the magnetic particles 10 to oscillate in the reaction chamber 20.

It is noted that according to some other embodiments, the magnet array is stationary, whereas the reaction chamber is configured to be movable reciprocatingly (i.e. back and forth, or up and down, etc.) relative to the magnet array. When the reaction chamber is moving reciprocatingly, the magnetic particles may oscillatingly move in a corresponding manner. When the reaction chamber stops moving, a stationary magnetic field can cause the magnetic particles to immobilize (not shown).

In another specific embodiment as illustrated in FIG. 5B, a substantially same electromagnet array as shown in FIGS. 4A and 4B is provided, which also comprises a total of four electromagnets (i.e., EM1, EM2, EM3 and EM4). As shown in the figure, electrical signals are alternately provided to two opposing EM2 and EM4 (EM1 and EM3 are not used), thereby causing the two opposing electromagnets to be alternately activated, which in turn can cause the magnetic particles 10 to oscillatingly move (as indicated by the two double-headed arrows drawn in the reaction chamber 20) in the liquid medium in the reaction chamber 20. However, it is possible to have a different pair of electromagnets to be alternately activated, e.g. EM1 and EM3, thereby causing the magnetic particles 10 to oscillatingly move in a different direction or in a different portion of the reaction chamber 20.

It is noted that in addition to the above two types of movement of the magnetic particles (i.e. swirling and oscillating), other types of movements, such as irregular movements induced by moving the magnet array irregularly, are also possible, which are also covered by the disclosure.

In order to actuate the generation of the magnetic field so as to cause the magnetic particles to move in the liquid medium substantially on a plane crossing the reaction chamber in any of the embodiments of the magnetic particles mixing method as described above and illustrated in FIGS. 1, 2A-2B, 3A-3B, 4A-4B and 5A-5B, a magnetic field generating assembly can be utilized, which is operably coupled with the reaction chamber.

In embodiments of the method such as those illustrated in FIG. 2A, the magnetic field generating assembly can comprise a magnetic array comprising at least one magnet (e.g. a single magnet M in the figures), and can further comprise a first motor that is operably connected with the magnet array. The first motor is configured to drive the magnet array to rotate around the reaction chamber with a rotational plane. When the first motor drives the magnet array to rotate, a rotating magnetic field can be generated, causing the magnetic particles 10 to swirl in the reaction chamber 20 (as illustrated in FIG. 2A), and the swirling plane of the magnetic particles 10 is substantially parallel to the rotational plane of the magnet array. When the first motor stops, a stationary magnetic field is generated, causing the magnetic particles 10 to immobilize (as illustrated in FIG. 2B).

Similarly in embodiments of the method where the reaction chamber is spinnable, the magnetic field generating assembly includes a magnet array comprising one or more permanent magnets or electromagnets, which is stationarily arranged in a proximity of the reaction chamber. The magnetic field generating assembly further comprises a second motor, which is operably connected with the reaction chamber. The second motor is further configured to drive the reaction chamber to spin with a spinning plane. When the reaction chamber spins, a relative rotating magnetic field can be generated, which may cause the magnetic particles to swirl in the reaction chamber, and the swirling plane of the magnetic particles is substantially parallel to the spinning plane of the reaction chamber. When the second motor stops, a stationary magnetic field is generated, which can cause the magnetic particles to immobilize.

In embodiments of the method where the magnet array is capable of having a reciprocating movement relative to the reaction chamber, such as those illustrated in FIG. 5A, the magnetic field generating assembly can comprise a movable magnetic array comprising at least one magnet (e.g. a single magnet M in FIG. 5A), and can further comprise a third motor that is operably connected with the magnet array. The third motor is configured to drive the movable magnet array to reciprocatingly move, thereby generating oscillating magnetic field that can cause the magnetic particles to oscillate in the reaction chamber.

In other embodiments of the method where the reaction chamber is capable of having a reciprocating movement relative to the magnet array, the magnetic field generating assembly can comprise a movable reaction chamber and a fourth motor that is operably connected with the reaction chamber. The third motor is configured to drive the movable reaction chamber to reciprocatingly move, thereby causing the magnetic particles to oscillate in the reaction chamber.

It is noted that the above four different manners that respectively utilize the first, second, third, and fourth motors can be mixed according to some embodiments of the disclosure. For example, some embodiments may include both the first motor, and the second motor, so as to allow the simultaneous rotation of the magnet array around the reaction chamber and spinning of the reaction chamber.

In embodiments of the method such as those illustrated in FIG. 4A, the magnetic field generating assembly can comprise an electromagnet array having at least two electromagnets, each arranged in a proximity of the reaction chamber 20, and can further comprise a first controller that is communicatively coupled to each of the at least two electromagnets in the electromagnet array. The first controller is configured to provide electrical signals to, and to thereby activate, the at least two electromagnets in the electromagnet array in a coordinating manner so as to form a composite rotating magnetic field (as illustrated in FIG. 4A) allowing the magnetic particles 10 to swirl in the reaction chamber 20, or to form an oscillating magnetic field (as illustrated in FIG. 5B) allowing the magnetic particles 10 to oscillate in the reaction chamber 20, or to form a stationary magnetic field (as illustrated in FIG. 4B) allowing the magnetic particles 10 to immobilize.

With regard to the aforementioned movement (b), i.e., the relative reciprocating movement of the magnetic particles with respect to the movement plane of the magnetic particles that is induced by the external magnetic field, different configurations are also possible depending on different embodiments. A reciprocation generating assembly can be utilized, which is operably coupled with the reaction chamber and/or the magnet/electromagnet array, and can work in different manners according to different embodiments of the disclosure.

In some embodiments, it can be configured such that the magnetic field does not move, whereas the reaction chamber is driven to be capable of moving reciprocatingly (i.e. up and down or back and forth). As such, the reciprocation generating assembly may comprise a fifth motor that is operably connected with the reaction chamber, which can be realized, for example, by means of a reaction chamber holder that is arranged to fixedly connect with the reaction chamber. The fifth motor is operably connected to the reaction chamber holder, and is configured to directly drive the reaction chamber holder, and indirectly drive the reaction chamber, to move reciprocatingly, which can be, for example, along a direction that has a non-zero angle (e.g. right angle, or 90°) to the movement plane of the magnetic particles.

In some other embodiments, it can be configured such that the reaction chamber does not move, whereas the magnetic field is driven to move reciprocatingly (i.e. up and down or back and forth). It can be realized by configuring such movable magnet array or movable electromagnet array. As such, the reciprocation generating assembly in these embodiments may comprise a sixth motor that is operably connected with the magnet array, which can be realized, for example, by means of a magnet/electromagnet array platform. The sixth motor is configured to drive the magnet array to move reciprocatingly, which can be, for example, along a direction that has a non-zero angle (e.g. right angle, or 90°) to the movement plane of the magnetic particles.

In yet some other embodiments, it can be configured such that the reaction chamber and the magnetic field are both driven to move reciprocatingly (i.e. up and down or back and forth). As such, the reciprocation generating assembly in these embodiments may comprise two motors that are operably connected with the reaction chamber and the magnet array, respectively. The two motors are coordinately controlled to realize the relative reciprocating movement of the magnetic particles with respect to the movement plane of the magnetic particles.

According to yet some other embodiments of the present disclosure, the magnetic particles mixing method comprises:

S100′: providing at least two magnetic fields to the reaction chamber, wherein each of the at least two magnetic fields is capable of, upon activation, causing the magnetic particles to move in the liquid medium substantially on a plane crossing the reaction chamber corresponding thereto, and planes corresponding to the at least two magnetic fields on which the magnetic particles move are not on a same plane; and

S200′: controlling the at least two magnetic fields such that only one different magnetic field is alternately activated at a different timepoint.

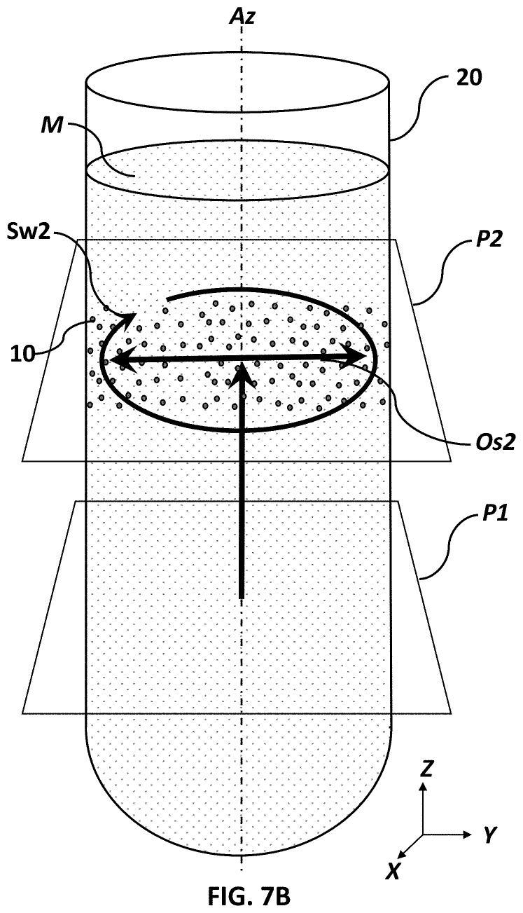

According to certain embodiments as illustrated in FIG. 6, a total of two magnetic fields are externally provided to the reaction chamber 20 that accommodates the liquid medium Min which the magnetic particles 10 are suspended. The two external magnetic fields include a first magnetic field (denoted as MF1) and a second magnetic field (denoted as MF2), which are configured to be alternately activated, i.e., when the first magnetic field is activated, the second magnetic field is turned off; and when the second magnetic field is activated, the first magnetic field is turned off.

Each of the two magnetic fields is configured, when activated, to cause the magnetic particles 10 to move (e.g. swirl, oscillate, etc.) substantially on a corresponding plane that crosses the reaction chamber. As specifically shown in FIG. 6, when the first magnetic field is turned on while the second magnetic field is turned off, the first magnetic field can cause the magnetic particles 10 to move substantially on the plane P1 (i.e. “movement plane”, which is substantially parallel to a plane formed by the X-axis and the Y-axis in the XYZ coordinate system shown in the figure), and such movement of the magnetic particles 10 on the movement plane P1 may include swirling (as indicated by the clockwise arrow Sw1 in the figure, which can be counterclockwise as well), oscillating (as indicated by the horizontal double-headed arrow Os1 in the figure, which can be other directions as well), or other types of movement. Similarly upon activation of the second magnetic field (when the first magnetic field is turned off), the magnetic particles 10 can move (e.g. swirl, as indicated by Sw2; or oscillate, as indicated by Os2, or other types of movement) the substantially on the movement plane P2. The movement planes P1 and P2 are stocked over one another (i.e. are substantially parallel to one another). Further optionally and preferably, the swirling and/or oscillating magnetic particles can form a homogenous cloud when any of the two magnetic fields is activated. In this specific embodiment shown in FIG. 6, although it is illustrated that the two movement planes P1 and P2 are parallel to each other, it is noted that it is not necessary.

As further shown in FIG. 6, the alternate activation of the two magnetic fields (MF1 and MF2) can realize that the magnetic particles are able to move (e.g. swirl or oscillate, etc.) on each movement plane that is determined by the corresponding magnetic field, and travel along a direction that is substantially perpendicular to the movement planes (as indicated by the vertical double-headed arrow between the two movement planes P1 and P2, which is substantially parallel to the Z-axis of the XYZ coordinate system).

It is to be noted that the method shown in FIG. 6 serves only illustrating purposes only, and there is no limitation to the reaction chamber or to the two movement planes P1 and P2 for the magnetic particles. The reaction chamber can have a spatial configuration other than the upright configuration as shown in FIG. 4, which can be, for example, horizontally arranged, or have any other angles to the horizontal plane, and in these examples, the reaction chamber may be a portion of a channel where the liquid medium is flowing. Similarly, each of the two movement planes P1 and P2 can have a spatial configuration other than having a right angle to the center axis of the reaction chamber as shown in FIG. 6, which can be any other angle. Also the two movement planes P1 and P2 don't have to be parallel to each other as illustrated in FIG. 6, and can have an angle therebetween, as long as the angle is not zero (i.e., the two movement planes P1 and P2 are not on a same plane).

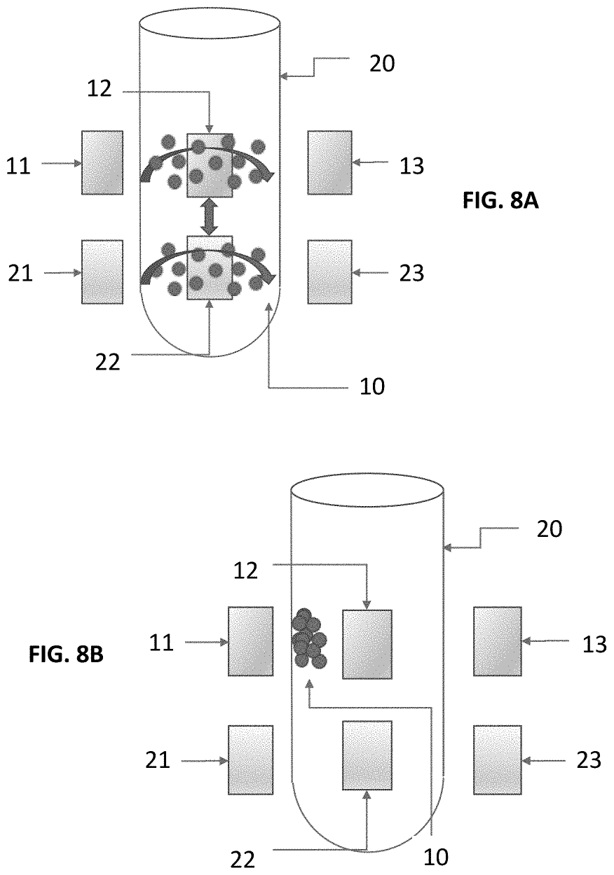

FIGS. 7A and 7B respectively illustrate the working of the embodiments of the magnetic particles mixing method shown in FIG. 6 at two different timepoints.

When MF1 is originally activated whereas MF2 is deactivated, the magnetic particles 10 can move (e.g. swirl or oscillate, as indicated by the arrows Sw1 and Os1, among others) within the reaction chamber 20 on substantially the movement plane P1 that is determined by MF1, as illustrated in FIG. 7A.

Then MF1 is deactivated and MF2 is activated, and the magnetic particles 20 can travel to the movement plane P2 under the effect of MF2 (as indicated by the upward arrow in FIG. 7B). After travel, the magnetic particles 20 can subsequently move (e.g. swirl or oscillate, as indicated by the arrows Sw2 and Os2, among others) within the reaction chamber 20 on substantially the movement plane P2 that is determined by MF2, as illustrated in FIG. 7B.

Then MF2 is deactivated and MF1 is activated, and the magnetic particles 20 can travel back to the movement plane P1 under the effect of MF1 (as indicated by the downward arrow in FIG. 7A). After travel, the magnetic particles 20 can subsequently move (e.g. swirl or oscillate, etc.) within the reaction chamber 20 on substantially the movement plane P1, as illustrated in FIG. 7A.

Then MF1 is deactivated and MF2 is activated, and the magnetic particles 20 can travel back to the movement plane P2 and move (e.g. swirl or oscillate, etc.) within the reaction chamber 20 on substantially the movement plane P2, as illustrated in FIG. 7B. The series go on and on.

As such, in the embodiments of the method illustrated herein, by switching on MF1 and MF2 in an alternate manner (i.e. only one different magnetic field is activated at a different timepoint), it can actuate the movement (i.e. swirling, and/or oscillating, etc.) of the magnetic particles on the movement plane(s) and the travelling of the magnetic particles between the two movement plane(s) magnetic fields.

It is noted that in addition to the above described and illustrated embodiments where there are a total of two magnetic fields, according to other embodiments, the number of the at least two magnetic fields may be more than two. As such, there may be m magnetic fields, denoted as MF₁, MF₂, . . . , MFₘ (m>1), whose rotation planes are not on a same plane. It is further configured such that only one different magnetic field is alternately activated at a different timepoint. For example, at a timepoint Tₓ (x is any positive integer), MFᵢ (i is any integer between 1 through m) is switched on whereas all other MFs are switched off, and the magnetic particles can move (e.g. swirl or oscillate, ect.) substantially on the rotation plane Pᵢ determined by MFᵢ. At a next time point Tₓ₊₁, MTⱼ (j is any integer between 1 through m, and j is not equal to i) is switched on whereas all other MFs are switched off, and the magnetic particles can travel to the rotation plane Pⱼ determined by MTⱼ and subsequently move (e.g. swirl or oscillate, ect.) substantially on the rotation plane Pⱼ.

Herein, each of the at least two magnetic fields may comprise electromagnet array, which comprises at least two electromagnets. As such, the step S100′ of the mixing method may comprise: providing at least two electromagnet arrays in a proximity of the reaction chamber; and the step S200′ may comprise: coordinately providing electrical signals to all electromagnets in the at least two electromagnet arrays.

According to some embodiments, the coordinately providing electrical signals to all electromagnets in the at least two electromagnet arrays may comprise: alternately providing electrical signals to the at least two electromagnets of the each of the at least two electromagnet arrays.

In order to actuate the above coordinated working of the at least two magnetic fields, a magnetic particle manipulating assembly can be configured, which is operably coupled with, and configured to provide at least two magnetic fields to, the reaction chamber.

According to some embodiments of the present disclosure, the magnetic particle manipulating assembly comprises at least two electromagnet arrays, each comprising at least two electromagnets which are all arranged around the reaction chamber. The magnetic particle manipulating assembly further comprises a second controller, which is communicatively coupled to, and configured to coordinately providing electrical signals to, all electromagnets in the at least two electromagnet arrays, so as to form the at least two magnetic fields.

In certain embodiments, the magnetic particle manipulating assembly comprises a total of two electromagnet arrays, each comprising at least two electromagnets which are spatially arranged around the reaction chamber. According to one further specific embodiment, each of the two electromagnet arrays comprises a total of three electromagnets, which are spatially arranged around the reaction chamber.

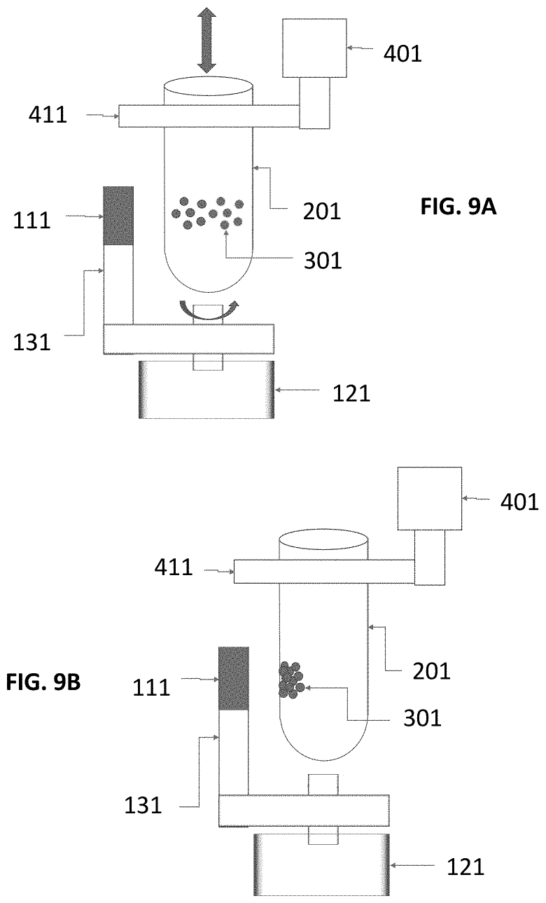

As illustrated in FIGS. 8A and 8B, this embodiment substantially involves the use of two electromagnet arrays (i.e. a first array, comprising electromagnets 11, 12 and 13; and a second array, comprising electromagnets 21, 22 and 23), which are respectively arranged at different lays around the reaction chamber 20. All electromagnets of the two electromagnet arrays are under tight control by a controller (i.e. second controller as mentioned above) to thereby work in a coordinated manner, so as to alternately form two corresponding magnetic fields, thereby actuating an efficient mixing of the magnetic particles 10 with the liquid medium (not shown) contained in the reaction chamber 20.

Specifically, as shown in FIG. 8A, at a first timepoint, the electromagnet array (11, 12 and 13) is switched on and the electromagnet array (21, 22 and 23) is switched off, and the magnetic particles can thus form a swirling cloud at a portion of the reaction chamber 20 corresponding to the electromagnet array (11, 12 and 13). At a second timepoint, the electromagnet array (11, 12 and 13) is switched off and the electromagnet array (21, 22 and 23) is switched on, and the magnetic particles can first migrate/travel to a portion of the reaction chamber 20 corresponding to the electromagnet array (21, 22 and 23) where they further form a swirling cloud. As such, an efficient mixing of the magnetic particles 10 with the liquid medium can be achieved.

It is further noted that when the electrical signal is sent to only one of the six electromagnets (e.g. electromagnet 11), a stationary magnetic field can thereby be formed, which allows the magnetic particles 10 to immobilize (i.e. form a pellet) on a portion of an inner wall of the reaction chamber 20 that immediately faces electromagnet 11, as illustrated in FIG. 8B. As such, the magnetic particles 10 can be separated from the liquid medium (not shown), which further allows for subsequent manipulations (e.g. capture of target molecules by means of magnetic particles that are surface-coated with ligand molecules that specifically bind to the target molecules).

In a second aspect, the present disclosure further provides an apparatus for mixing magnetic particles with a liquid medium in a reaction chamber (i.e. “magnetic particles mixing apparatus” or “apparatus” hereinafter), which substantially applies the magnetic particles mixing method as provided in the first aspect of the present disclosure.

According to some embodiments, the mixing apparatus is configured to apply the magnetic particles mixing method according to the embodiments as illustrated in FIG. 1, and as such, the apparatus comprises a magnetic field generating assembly, and a reciprocation generating assembly.

The magnetic field generating assembly is operably coupled with the reaction chamber, and is configured to generate a magnetic field to the reaction chamber so as to cause the magnetic particles to move in the liquid medium substantially on a plane crossing the reaction chamber. The reciprocation generating assembly is operably coupled with the reaction chamber and/or the rotating magnetic field generating assembly, and is configured to cause the magnetic particles to have a relative reciprocating movement with respect, and along a direction has a non-zero angle, to the plane. As explained elsewhere, the term “move” may include “swirl”, “oscillate”, or others.

According to some embodiments, the apparatus substantially applies one of the aforementioned embodiments of the method where the magnetic field is generated by rotating a magnet array around the reaction chamber, as illustrated in FIG. 2. As such, the magnetic field generating assembly comprises a magnetic array and a first motor. The magnetic array comprises at least one magnet. The first motor is operably connected with the magnet array, and is configured to drive the magnet array to rotate around the reaction chamber to thereby generate the magnetic field that causes the magnetic particles to move in the liquid medium substantially on a plane crossing the reaction chamber.

Herein, the magnet array may optionally comprise at least one permanent magnet, or may optionally comprise at least one electromagnet, or may optionally mixedly comprise at least one permanent magnet and at least one electromagnet.

Herein the number of the at least one magnet in the magnetic array may vary. According to one embodiment of the apparatus, there is only one magnet (permanent magnet or electromagnet) in the magnet array, and the apparatus substantially applies the mixing method as specifically illustrated in FIG. 3A and described in relevant paragraphs in the first aspect of the description. It is further noted that this embodiment of the apparatus can also be utilized for immobilizing the magnetic particles from the liquid medium, which substantially applies the method as specifically illustrated in FIG. 3B and described in relevant paragraphs in the first aspect of the description.

In certain embodiments, the magnetic field generating assembly may include, in addition to a magnetic array similar to the embodiments described above, a second motor, which is operably connected with the reaction chamber, and is configured to drive the reaction chamber to spin around the reaction chamber to thereby allow the magnetic particles to move in the liquid medium substantially on a plane crossing the reaction chamber.

According to some other embodiments, the apparatus substantially applies one of the aforementioned embodiments of the method as illustrated in FIG. 4A where the magnetic field is generated by means of an electromagnet array without rotating the electromagnet array around the reaction chamber. As such, the magnetic field generating assembly comprises an electromagnet array and a first controller. The electromagnet array comprises at least two electromagnets that are spatially arranged around the reaction chamber. The first controller is communicatively coupled to each of the at least two electromagnets, and is configured to provide electrical signals to, and to thereby activate, the at least two electromagnets in a coordinating manner so as to compositely form the magnetic field.

Further according to certain embodiments, the first controller is configured to alternately activate the at least three electromagnets in the electromagnet array to thereby compositely generate the rotating magnetic field.

Herein the number of electromagnets in the electromagnetic array may vary. According to one specific embodiment which will be described in more detail in Example 2, there are a total of three electromagnets in the electromagnet array. According to yet another embodiment of the apparatus, there are a total of four electromagnets in the electromagnet array, and the apparatus substantially applies the mixing method as specifically illustrated in FIG. 4A and described in relevant paragraphs in the first aspect of the description. It is further noted that this embodiment of the apparatus can also be utilized for immobilizing the magnetic particles from the liquid medium, which substantially applies the method as specifically illustrated in FIG. 4B and described in relevant paragraphs in the first aspect of the description.

In addition to the above embodiments of the apparatus where the magnetic field provided by the magnetic field generating assembly causes the magnetic particles to swirl in the reaction chamber on the movement plane, other embodiments of the apparatus also exist, and the magnetic field provided by the magnetic field generating assembly can cause the magnetic particles to have other type of movements, such as oscillation.

As such, according to some embodiments of the apparatus as illustrated in FIG. 5A, the magnetic field generating assembly may include, in addition to a magnetic array, a third motor that is operably connected with the magnet array. The third motor is configured to drive the magnet array to reciprocatingly move. According to some other embodiments of the apparatus, the magnetic field generating assembly may include, in addition to a magnetic array, a fourth motor that is operably connected with the reaction chamber. The fourth motor is configured to drive the reaction chamber to reciprocatingly move.

It is noted that in certain embodiments where an electromagnet array is applied such as those illustrated in FIGS. 4A and 4B where the magnetic particles can swirl in the reaction chamber, the same apparatus can be used to cause the magnetic particles to oscillate, as illustrated in FIG. 5B.

Regardless of whether the magnetic field is generated by rotating or reciprocatingly moving a magnet array around the reaction chamber or by means of a stationarily arranged electromagnet array, the apparatus utilizes a reciprocation generating assembly to actuate the relative reciprocating movement of the magnetic particles with respect, and along a direction that has a non-zero angle, to the movement plane. Different embodiments exist.

According to some embodiments, the apparatus substantially applies one of the aforementioned embodiments of the method where only the reaction chamber is driven to move. As such, the reciprocation generating assembly can comprise a fifth motor, which is operably coupled with the reaction chamber by means of, for example, a reaction chamber holder that is fixedly connected with the reaction chamber. The fifth motor is configured to drive the reaction chamber to move reciprocatingly.

According to some other embodiments, the apparatus substantially applies one of the aforementioned embodiments of the method where only the magnetic field is driven to move. As such, the reciprocation generating assembly can comprise a sixth motor, which is operably coupled with a magnet/electromagnet array by means of, for example, a magnet/electromagnet array platform that is operably connected with the magnet/electromagnet array. The sixth motor is configured to drive the magnet array or the electromagnet array to move reciprocatingly.

According to yet some other embodiments, the apparatus substantially applies one of the aforementioned embodiments of the method where both the reaction chamber and the rotating magnetic field are driven to move. As such, the reciprocation generating assembly can comprise two motors. The connection and working mechanisms for the two motor can be similar to the fifth motor and the sixth motor as described above, thus the description of these embodiments can be referenced to the above and is skipped herein.

According to some embodiments, the apparatus is configured to apply the magnetic particles mixing method according to the embodiments as illustrated in FIG. 6, and as such, the apparatus comprises a magnetic particle manipulating assembly.

The reaction chamber accommodates the liquid medium containing the magnetic particles, and the magnetic particle manipulating assembly is operably coupled with, and is configured to provide at least two magnetic fields to, the reaction chamber. Herein, each of the at least two magnetic fields is capable of, upon activation, causing the magnetic particles to move in the liquid medium substantially on a plane crossing the reaction chamber corresponding thereto, and planes corresponding to the at least two magnetic fields on which the magnetic particles move are not on a same plane. The at least two magnetic fields are further configured such that only one different magnetic field is alternately activated at a different timepoint.

The detailed working mechanism of these embodiments of the apparatus can reference the embodiments of the mixing method as illustrated in FIGS. 7A and 7B and relevant paragraphs in the first aspect of the disclosure, whose description will be skipped herein.

According to certain embodiments of the apparatus, the magnetic particle manipulating assembly comprises at least two electromagnet arrays and a second controller. Each of the at least two electromagnet arrays comprises at least two electromagnets, which are spatially arranged around the reaction chamber. The second controller is communicatively coupled to the at least two electromagnets in each of the at least two electromagnet arrays, and is configured to provide electrical signals thereto in a coordinating manner, so as to form the at least two rotating magnetic fields.

According to certain embodiments of the apparatus, there are a total of two electromagnet arrays in the magnetic particle manipulating assembly, and/or there are a total of three electromagnets in each such electromagnet array.

One specific embodiment of the apparatus substantially applies the mixing method as illustrated in FIG. 8A, which includes two electromagnet arrays, each comprising three electromagnets. The detailed description of the working mechanism of the apparatus can reference FIG. 8A and relevant description in the first aspect of the disclosure. It is further noted that this embodiment of the apparatus can also be utilized for immobilizing the magnetic particles from the liquid medium, which substantially applies the method as specifically illustrated in FIG. 8B and described in relevant paragraphs in the first aspect of the description.

In the following, two specific examples are provided.

### Example 1

This example represents one specific embodiment of a magnetic particles mixing apparatus that substantially applies the embodiment of the magnetic particles mixing method as illustrated in FIG. 3A, in which the rotating magnetic field is generated by mechanically rotating a single magnet.

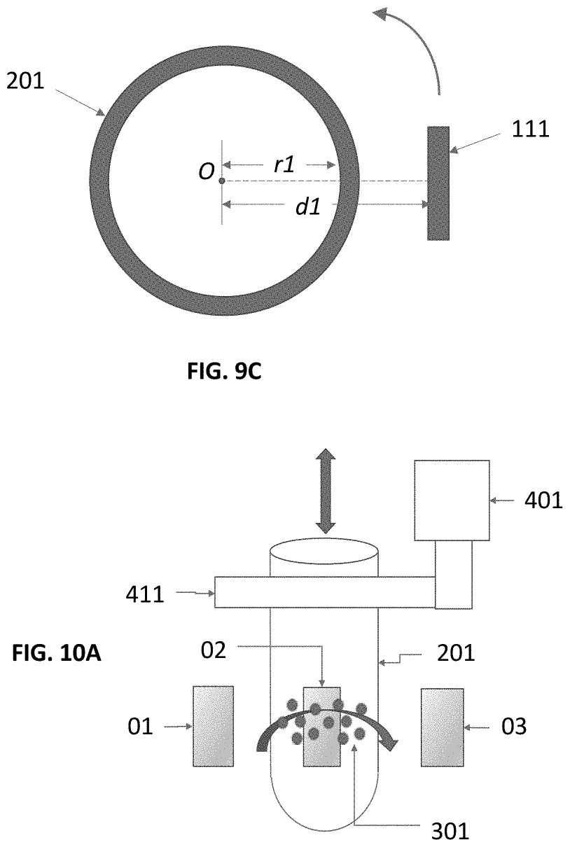

As specifically illustrated in FIGS. 9A and 9B, in this specific embodiment of the apparatus, the magnet array comprises one single magnet 111 (a permanent magnet or an electromagnet), which is operably connected with a motor 121 by means of a magnet holder 131, and the motor 121 is configured to drive the programmed horizontal rotation of the magnet 111 around a reaction chamber 201. The reaction chamber 201 is mechanically and operably connected to another motor 401 by means of a reaction chamber holder 411, and the motor 401 is configured to drive the reaction chamber 201 to move vertically. A plurality of magnetic particles 301 are suspended in a liquid medium in the reaction chamber 201.

In this specific example, the motor 121 drives the magnet 111 to rotate, thereby creating a rotating magnetic field (as illustrated by a rotation arrow), which in turn drives the magnetic particles 301 to form a swirling cloud in a portion of the liquid medium contained in the reaction chamber 201 that is covered by the magnetic field. This can be combined with a vertical reciprocating movement of the reaction chamber 201 through the magnetic field by the motor 401 to allow for an efficient mixing of the magnetic particles 301 with the solution. Beads separation can be obtained by fixing the magnet 111 at a desired position to thereby immobilize the magnetic particles 301, thereby facilitating the separation thereof from the liquid medium. The apparatus can be controlled by a controller, such as an electronic controller, which is not shown in the two figures.

More specifically, FIGS. 9A and 9B respectively illustrate two different manipulations of the magnetic particles 301 for forming a swirling beads cloud in a liquid medium (such as a solution) in the reaction chamber 201 and for separation/isolation of the magnetic particles 301 from the liquid medium.

As illustrated in FIG. 9A, a mechanical device, such as a motor 121, is used to rotate the magnet 111 around the reaction chamber 201 to thereby create a rotating magnetic field (as illustrated by a rotation arrow), which in turn drives the magnetic particles 301 to form or maintain a magnetic particles cloud in a portion of the liquid medium within the reaction chamber 201 that is covered by the magnetic field. This can be optionally combined with a vertical reciprocating movement of the reaction chamber 201 through the rotating magnetic field which is driven by another mechanical device, such as a motor 401, to thereby move the magnetic particles 301 up or down the reaction chamber 201 through the rotating magnet field. These combined movements (i.e. the horizontal rotation and vertical reciprocating movement) together can create an effective contacting, mixing, or swirling of the magnetic particles 301 with the liquid medium, and can also facilitate the capture of the target molecules of interest from the liquid medium if specific ligands corresponding thereto are coupled onto the magnetic particles 301.

As further illustrated by FIG. 9B, separation of the magnetic particles 301 from the liquid medium can be obtained by fixing the magnet 111 at a desired position (i.e. stopping the magnet at the desired position) to thereby immobilize the magnetic particles 301 onto the inner wall of the reaction chamber 201, which can facilitate the separation/isolation of the immobilized magnetic particles 301 from the liquid medium.

FIG. 9C shows a top sectional view of the apparatus, further illustrating a spatial relationship between the magnet 111 and the reaction chamber 201, with r1 denoting a radius of the cylinder-shaped reaction chamber 201 (i.e. the distance of the wall of the reaction chamber 201 to the circle center O in the sectional view), d1 denoting a distance of the magnet 111 from the center of the reaction chamber 201, and the curved arrow denoting the rotational direction of the magnet. Herein optionally, the shape of the magnet 111 can have a straight shape (as shown in FIG. 9C) or a curved shape (not shown, preferably the curve has an equal distance to the center O of the regent chamber); the distance d1 can be adjusted to vary depending on the practical needs; the apparatus can be configured to allow the use of reaction chambers 201 with different sizes (i.e. different radiuses); and the rotating direction and/or rotating speed of the magnet 111, and/or the vertical reciprocating moving speed of the reaction chamber 201 can also be configured as adjustable (which can be realized by controller, such as an electronic controller (e.g. a processor), and can be programmed differently based on practical needs). Further optionally, there is no limitation on the size and/or shape of the reaction chamber 201 shown in FIGS. 9A and 9B, which has one closed end (i.e. bottom end that is closed) and one open end (i.e. top end that is open). For example, the reaction chamber 201 can have a shape other than the cylinder shown in FIGS. 9A and 9B, and alternatively can be a reagent channel with a liquid medium flowing therein and therethrough. Further alternatively, the reaction chamber 201 can be arranged in a non-upright orientation (e.g. horizontal, oblique, etc.).

### Example 2

This example substantially represents one specific embodiment of a magnetic particles mixing apparatus that substantially applies the embodiment of the magnetic particles mixing method that is similar to that illustrated in FIG. 4A, in which the rotating magnetic field is generated by coordinately controlling all electromagnets in an electromagnet array to work. The only difference is that the embodiment as described above and illustrated in FIG. 4A involves the use of four electromagnets in the electromagnet array, whereas Example 2 described herein uses three electromagnets in the electromagnet array.

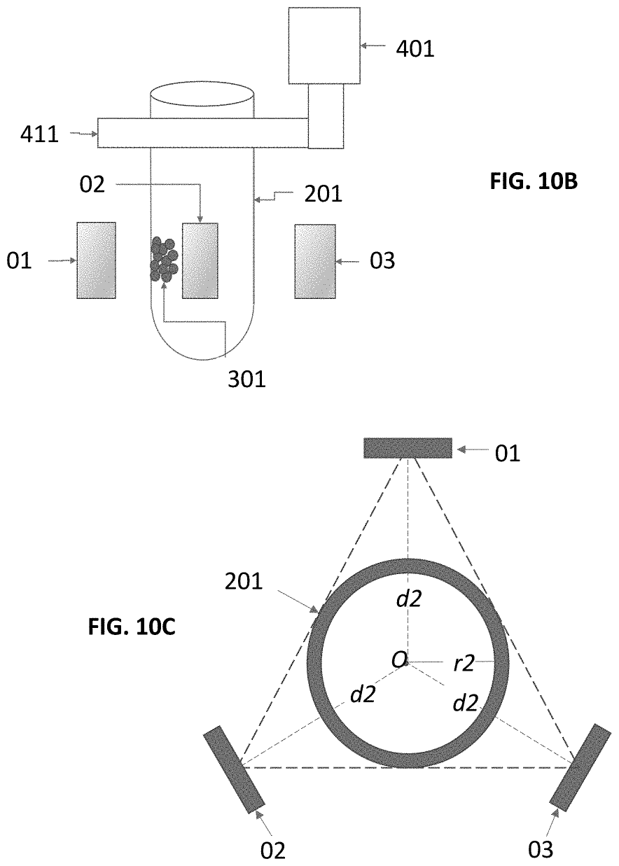

As specifically illustrated in FIGS. 10A and 10B, in this specific embodiment of the apparatus, the electromagnet array comprises three electromagnets 01, 02, and 03, which are stationarily arranged around a reaction chamber 201, and the three electromagnets 01, 02, and 03 are controlled to work coordinately to thereby form a rotating magnetic field. Furthermore, the reaction chamber 201 is mechanically and operably connected to a mechanical device (such as a motor 401) by means of a reaction chamber holder 411, and the motor 401 is configured to drive the reaction chamber 201 to move vertically. A plurality of magnetic particles 301 are suspended in a liquid medium in the reaction chamber 201.

This specific embodiment of the apparatus uses three electromagnets (01, 02, and 03) which are stationarily installed around the reaction chamber 201 in different guardant and are equally distant from one another. Current signals can be applied sequentially and alternately to the three electromagnets to thereby create a rotating magnetic field to drive the magnetic particles 301 to form a beads cloud in the area covered by the magnetic field, which is further combined to travelling the reaction chamber 201 vertically and reciprocatingly through the rotating magnetic field via the motor 401, so as to suspend, resuspend, or mix the magnetic particles 301 in the solution for a sufficient contact therebetween. After a desire time duration of mixing or suspension, beads separation can be subsequently performed by applying a current signal to one desired electromagnet so as to immobilize the magnetic particles 301 and to separate the magnetic particles 301 from the solution. The apparatus can be controlled by a controller, such as an electronic controller.

FIGS. 10A and 10B respectively illustrate two different manipulations of the magnetic particles 301 for forming a swirling beads cloud in a liquid medium in the reaction chamber 201 and for separation/isolation of the magnetic particles 301 from the liquid medium.

FIG. 10C shows a top sectional view of this specific embodiment of the apparatus, further illustrating a spatial relationship between the three electromagnets 01-03 and the reaction chamber 201, with r2 denoting a radius of the cylinder-shaped reaction chamber 201 (i.e. the distance of the wall of the reaction chamber 201 to the circle center O in the sectional view), d2 denoting a distance of each of the three magnets 01-03 from the center O of the reaction chamber 201. In this embodiment of the apparatus, a total of three electromagnets 01, 02, and 03 are used, which are arranged in an equilateral triangle symmetry around the center axis of a reaction chamber 201 (i.e. they are respectively arranged at the three vertices of an equilateral triangle with its center coinciding with the circle center O of the cylinder-shaped reaction chamber 201 in a sectional view, such that each of them has an equal distance d2 from the center O of the reaction chamber).

To suspend and mix, electrical signals (such as current signals) can be applied in a sequential and alternate manner to different electromagnets 01-03 to thereby create a rotating magnetic field to drive the magnetic particles to vortex or to form a beads cloud in a portion of the liquid medium within the reaction chamber 201 that is covered by magnetic field. In other words, with reference to FIG. 10C, the activation (i.e. by applying an electrical signal) of the three electromagnets 01-03 can have a sequence of 01->02->03, causing the magnetic field to rotate in a counterclockwise direction; or can have a sequence of 01->03->02 to have a clockwise rotating magnetic field, or can have a mixed manner (i.e. alternating between clockwise and counterclockwise). Similar to Example 1 as described above and illustrated in FIGS. 9A-9C, this example shown herein can also realize the reciprocating travelling of the reaction chamber 201 through the magnetic field by means of a mechanical device, such as the motor 401. After a desired time duration of mixing and suspension, beads separation can be subsequently performed by applying an electrical signal (e.g. a current signal) to one desired electromagnet (e.g. 01 as shown in the figure) to thereby immobilize or collect magnetic particles for separation from the liquid medium.

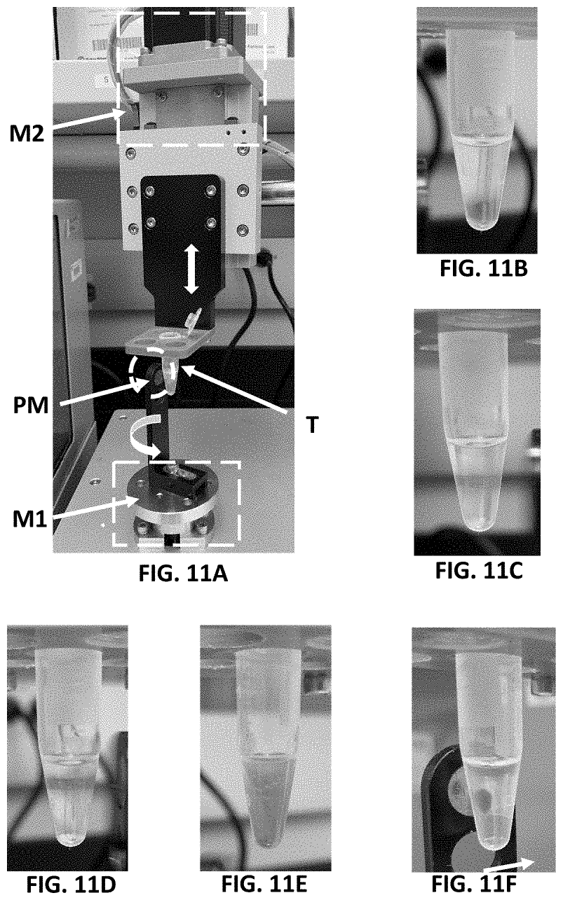

FIGS. 11A-11F show presentations of various stages during beads mixing and separation using a specific apparatus which is substantially based on Example 1 as described and illustrated above. As shown in FIG. 11A, the apparatus uses two motors (M1 and M2, as indicated by the two boxes with dotted lines) as the mechanical devices for respectively driving the rotation (as indicated by the counterclockwise arrow) of the magnet PM (as indicated by the circle with dotted line) and the vertical movement (as indicated by the upright double arrow) of the reaction chamber (i.e. tube 7). The magnetic particles (light brown color) form a swirling beads cloud driven by the magnet PM to the bottom of the tube T (FIG. 11B), the center of the tube T (FIG. 11C), or toward the top of the tube T (FIG. 11D), and as a homogenously stirring in the entire tube T (FIG. 11E). The separation of the magnetic particles driven by fixing the magnet PM at a desired position (FIG. 11F). Optionally, the rotation direction, speed, and the strength of the magnetic field formed by each electromagnetic assembly can be adjusted independently, and/or cooperatively, and/or in real-time varying manner.

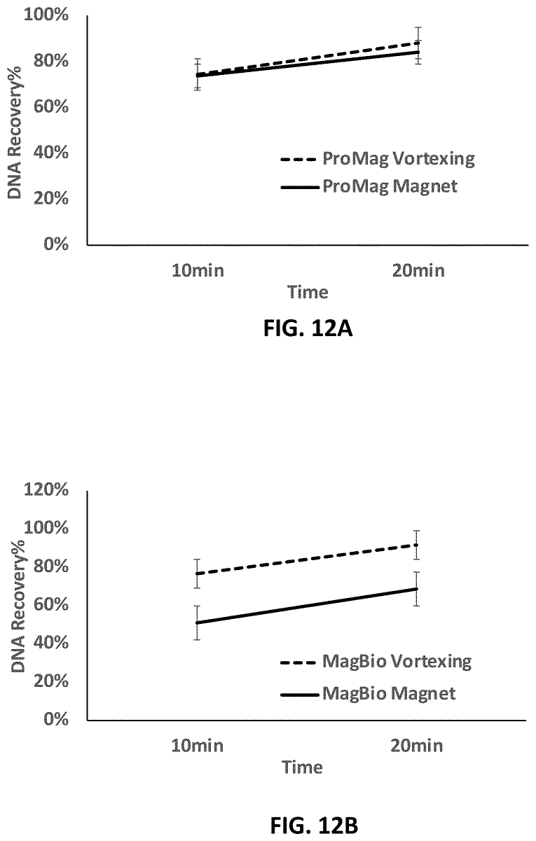

FIGS. 12A and 12B show the comparisons of the capability of magnetic beads to bind DNA between vortexing and magnet mixing using the magnetic beads manipulating prototype as described above and illustrated in FIG. 12A. Briefly, a test DNA was added into a DNA binding solution with 1 m-diameter ProMag silica beads (FIG. 12A) or 0.1 m-diameter MagBio carboxylated beads (FIG. 12B), and the above mixtures were mixed by either a vortex or the magnetic beads manipulating system for 10 and 20 min respectively to facilitate the test DNA to be captured by magnetic beads. A 10-15% recovery was obtained with no mixing or vortexing. At the end of mixing, bead separation was performed and the beads-captured test DNA was recovered from the beads by elution in water. The eluted DNA was quantitated by the Qubit fluorometric DNA quantitation (ThermoFisher Scientific) and the percentages of the recovery by vortex mixing (dashed line) or by magnet mixing (solid line) were calculated and compared to the amount of input DNA, and plotted as to the time of the mixing. The setting for the vortex mixing on the Fisher Vortex Genie was selected to be scale 8 of 10, which seems to obtain the highest recovery of DNA setting at given binding times of 10 and 20 min. 10 and 20 min were used as the binding times for this comparison. As shown in FIG. 12A, binding of the test DNA by the ProMag magnetic beads mixing driven by magnet rotation is as efficient as by vortexing, indicating a sufficient mixing can be realized through the magnet rotation. As further shown in FIG. 12B, the binding of the test DNA by MagBio beads mixed by magnet mixing was not as effective as vortexing, thus indicating that longer time will be needed as compared to vortexing for MagBio beads to have sufficient contact mixing driven by the magnet rotation.

The following are noted throughout the whole disclosure.

In any of the above embodiments, the rotating magnetic field can optionally be adjusted to have a constant or varying rotation speed, and/or to have a changing rotation direction.

As used in any of the above embodiments, the term “swirling magnetic particles cloud” or “swirling cloud” refers to a cloud of magnetic particles that are formed to suspend in the liquid medium under the action of a rotating magnetic field, which may take the forms of a spinning or swirling vortex.

In any of the above embodiments, the reaction chamber can take different forms. In certain embodiments, the reaction chamber can be a container having one closed end, and another end of the container can have an opening that may or may not be closed. Examples can include a reaction chamber, such as Eppendorf tube (e.g. centrifuge tubes), which has a closed end and an opening with a removable lid or a 96-well plat which has a closed end and an opening with a removable lid. In some other embodiments, the reaction chamber can have two open ends which can be, for example, part of a channel, and the liquid medium can flow inside the channel, and the reaction chamber is where the magnetic particles are mixed with the liquid medium utilizing the mixing method and/or utilizing the mixing apparatus as described above.

As used in any of the above embodiments, the term “magnetic particles” shall be interpreted to be exchangeable to “magnetic beads”, and shall include any particles that are magnetic, which may have different compositions, sizes, shapes, structures, and can have different surface modifications to be functionalized or have no modification at all. Each magnetic particle may optionally have a spherical shape, an oval shape, but can also be of an irregular shape. Each magnetic particle may optionally comprise a non-magnetic matrix (having a composition of a polymer (e.g. polystyrene), silica, etc.), and one or more magnetic micro-particles (i.e. are further embedded in the core (i.e. core-shell structure, with the polymer composition at the shell and the magnetic microparticle at the core) or in other portions of the polymer matrix, but can also have other compositions and structures. The magnetic microparticles for the magnetic particles as used herein can optionally comprise a paramagnetic material, and preferably comprise superparamagnetic particles. As used herein, a “paramagnetic” material refers to a material that can become magnetized when an external magnetic field is applied, but does not retain magnetization when the external magnetic field is removed. Examples typically include a ferro-magnetic substance such as iron-based oxides (e.g. magnetite (i.e. Fe₃O₄), maghemite (Fe₂O₃, y-Fe₂O₃) or cobalt ferrite (CoO.Fe₂O₃)), or certain pure transition metals (e.g. Co, Fe, or Ni). The term “superparamagnetic particles” further refer to a type of paramagnetic particles that typically do not agglomerate after the external magnetic field is removed.

Furthermore, the magnetic particles as used herein may optionally contain functional groups which are typically coated on the surface thereof, so as to provide various different functionalities. For example, the magnetic beads may be conjugated with certain oligonucleotides (DNA or RNA), proteins, enzymes, carbohydrates, compounds (e.g. EDTA-like chelators), etc., which can be used as a ligand for specifically recognizing and/or binding of certain target substances in the liquid medium, such as target nucleic acid fragments, target proteins, target cells (e.g. cancer cells or certain bacteria), target particles (e.g. virions), or target heavy metals, etc. In another example, the magnetic beads may be conjugated with certain fluorescent, magnetic, or plasmonic groups, allowing certain operations, such as detection or monitoring, to be performed. The coating of the functional groups to the surface of the magnetic beads may involve the covalent coupling of the functional groups to the surface of the magnetic beads, commonly through a carboxyl or amino groups.

Herein preferably, the magnetic beads used in the present disclosure are substantially uniform in size, shape, and magnetic and chemical properties, so as to obtain a high level of reproducibility.

It is noted that in any of the embodiments of the apparatus as described above, and throughout the whole disclosure as well, the term “motor” can generally refer to a mechanical device (such as an engine, an electrical motor, a belt, a screw, etc.) that can drive an object to realize a certain specified motion, such as spinning/rotation, linear displacement, or other types of displacement, thereof.

As used herein, the term “controller” refers to as a computer-implemented functional entity that is communicatively connected to, and configured to provide electrical signals to, a target object or a set of target objects (e.g. the at least two electromagnets in the electromagnet array), for realizing a prescribed functionality thereof. A controller as such can include both hardware components and software components. In certain embodiments, a controller comprises a processor and a memory. The processor is configured to execute the computer program stored in the memory. The memory is configured to store a computer program comprising executable instructions that when executed by a processor, carry out certain prescribed functionalities, which includes, for example, sending appropriate electrical signals to the at least two electromagnets in the electromagnet array to thereby form a rotating magnetic field or to immobilize the magnetic particles as illustrated in FIGS. 3A and 3B, or to coordinate the working of the at least two electromagnet arrays as illustrated in FIGS. 6A and 6B. Examples of the memory can include a random access memory (RAM) and/or a non-volatile memory (NVM, e.g. a disc storage). The processor can be a general processor, such as a central processing unit (CPU), a network processor (NP), a digital signal processor (DSP), an application specific integrated circuit (ASIC), a programmable logic device (e.g. field programmable gate array (FPGA)), a discrete gate or transistor logic device, or a discrete hardware component, etc.

It should be noted that throughout the disclosure, relational terms such as “first,” “second”, and the like, are only meant to distinguish one entity or operation from another, and do not necessarily require or imply any such actual relationship or order between these entities or operations. As used herein, the terms “comprise,” “include,” “contain,” and the like, are synonymous and are used inclusively, in an open-ended fashion, and do not exclude additional elements, features, steps, acts, operations, and so forth.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the scope of the invention, and all such variations are intended to be included within the scope of the following claims. All references cited herein are incorporated by reference in their entireties.

1. A method for mixing magnetic particles with a liquid medium in a reaction chamber, comprising: simultaneously
providing a magnetic field to the reaction chamber, thereby causing the magnetic particles to move in the liquid medium substantially on a plane crossing the reaction chamber; and
controlling such that the magnetic particles have a relative reciprocating movement with respect to, and along a direction that has an angle to, the plane, wherein the angle is not zero.

2. The method of claim 1, wherein the magnetic field is generated from a magnet array comprising at least one magnet, wherein each of the at least one magnet in the magnet array is a permanent magnet or an electromagnet.

3. The method of claim 2, wherein the providing a magnetic field to the reaction chamber comprises at least one of:
rotating the magnet array around the reaction chamber;
spinning the reaction chamber;
driving the magnet array to reciprocatingly move; or
driving the reaction chamber to reciprocatingly move.

4. The method of claim 3, wherein the providing a magnetic field to the reaction chamber comprises:
rotating the magnet array around the reaction chamber;

5. The method of claim 1, wherein the magnetic field is generated from an electromagnet array comprising at least two electromagnets, wherein the providing a magnetic field to the reaction chamber comprises:
coordinately providing electrical signals to the at least two electromagnets in the electromagnet array, thereby forming the magnetic field.

6. The method of claim 5, wherein the coordinately providing electrical signals to the at least two electromagnets in the electromagnet array comprises:
alternately providing electrical signals to the at least two electromagnets in the electromagnet array.

7. The method of claim 1, wherein the controlling such that the magnetic particles have a relative reciprocating movement with respect to, and along a direction that has an angle to, the plane comprises:
driving the reaction chamber to move reciprocatingly.

8. The method of claim 1, wherein the magnetic field is generated by a magnet array or an electromagnet array, wherein the controlling such that the magnetic particles have a relative reciprocating movement with respect to, and along a direction that has an angle to, the plane comprises:
driving the magnet array or the electromagnet array to move reciprocatingly.

9. A method for mixing magnetic particles with a liquid medium in a reaction chamber, comprising:
providing at least two magnetic fields to the reaction chamber, each capable of, upon activation, causing the magnetic particles to move in the liquid medium substantially on a plane crossing the reaction chamber corresponding thereto, wherein planes corresponding to the at least two magnetic fields on which the magnetic particles move are not on a same plane;
controlling the at least two magnetic fields such that only one different magnetic field is alternately activated at a different timepoint.

10. The method of claim 9, wherein:
the providing at least two magnetic fields to the reaction chamber comprises:
providing at least two electromagnet arrays in a proximity of the reaction chamber, wherein each of the at least two electromagnet arrays comprises at least two electromagnets;
and
the controlling the at least two magnetic fields comprises:
coordinately providing electrical signals to all electromagnets in the at least two electromagnet arrays.

11. The method of claim 10, wherein the coordinately providing electrical signals to all electromagnets in the at least two electromagnet arrays, thereby forming the at least two magnetic fields comprises:
alternately providing electrical signals to the at least two electromagnets of the each of the at least two electromagnet arrays.

12. An apparatus for mixing magnetic particles with a liquid medium in a reaction chamber, comprising:
a magnetic field generating assembly, operably coupled with the reaction chamber, wherein the magnetic field generating assembly is configured to generate a magnetic field to the reaction chamber so as to cause the magnetic particles to move in the liquid medium substantially on a plane crossing the reaction chamber; and
a reciprocation generating assembly, operably coupled with one or both of the reaction chamber and the magnetic field generating assembly, wherein the reciprocation generating assembly is configured to cause the magnetic particles to have a relative reciprocating movement with respect to, and along a direction that has an angle, to the plane, wherein the angle is not zero.

13. The apparatus of claim 12, wherein the magnetic field generating assembly comprises a magnetic array comprising at least one magnet, each in a proximity of the reaction chamber, wherein each of the at least one magnet is a permanent magnet or an electromagnet.

14. The apparatus of claim 13, wherein the magnetic field generating assembly further comprises at least one of:
a first motor operably connected with the magnet array, configured to drive the magnet array to rotate around the reaction chamber;
a second motor operably connected with the reaction chamber, configured to drive the reaction chamber to spin;
a third motor operably connected with the magnet array, configured to drive the magnet array to reciprocatingly move; or
a fourth motor operably connected with the reaction chamber, configured to drive the reaction chamber to reciprocatingly move.

15. The apparatus of claim 13, wherein a number of the at least one magnet in the magnet array is one.

16. The apparatus of claim 12, wherein the magnetic field generating assembly comprises:
an electromagnet array comprising at least two electromagnets, each in a proximity of the reaction chamber; and
a first controller communicatively coupled to each of the at least two electromagnets, wherein the first controller is configured to coordinately provide electrical signals to the at least two electromagnets in the electromagnet array so as to compositely form the magnetic field.

17. The apparatus of claim 16, wherein the first controller is configured to alternately provide electrical signals to the at least two electromagnets in the electromagnet array.

18. The apparatus of claim 16, wherein a number of the at least two electromagnets in the electromagnet array is three.

19. The apparatus of claim 12, wherein the reciprocation generating assembly comprises a fifth motor operably connected with the reaction chamber, wherein the fifth motor is configured to drive the reaction chamber to move reciprocatingly.

20. The apparatus of claim 12, wherein a magnetic field generating assembly comprises a magnet array or an electromagnet array, wherein the reciprocation generating assembly comprises a sixth motor operably connected with the magnet array, wherein the sixth motor is configured to drive the magnet array or the electromagnet array to move reciprocatingly.
